(19) United States
(12) Patent Application Publication
(10) Pub. No.: US 2002/0100326 A1
(43) Pub. Date: Aug. 1, 2002

(54) Method and apparatus for measuring ultrasonic properties of an object

(75) Inventor: Uri Stein, Rosh Ha'ain (IL)

Correspondence Address: Dr.Mark Friedman LTD, c/o Bill Polkinghorn -Discovery Dispatch, 9003 Florin Way, Upper Marlboro, MD, 20772, US

(73) Assignee: IMADENT LTD.

(21) Appl. No.: 09/727,754

(22) Filed: Dec. 4, 2000

(51) Int. Cl. G01N 29/02

(52) U.S. Cl. 73/597; 73/602

(57) ABSTRACT

A method and apparatus for measuring ultrasonic properties within an object under evaluation, in particular, acoustic velocities and attenuation-frequency functions within the object. A transducer transmits a train of ultrasonic energy toward a reference object, and receives ultrasonic echoes reflected therefrom. The transducer transmits an identical train of ultrasound toward the object under evaluation, and receives ultrasonic echoes reflected from the latter object. A computer analyzes each of the received echoes using a Fast Fourier Transform algorithm, to produce for each an array of amplitudes per frequencies. The computer divides the array produced from the object echoes by the array of the reference echo to produce a third array of amplitudes per frequencies, which is partially characterized by a recurring periodical increase and decrease in amplitude. The computer finds the frequency of such recurrence, and calculates an acoustic velocity within the object, based on that frequency of recurrence and on the predetermined thickness of the object under evaluation. A display displays the calculated acoustic velocity. Based on the determined frequency of recurrence in the produced array of amplitudes per frequencies, the computer finds a subset of amplitudes per frequencies, which forms a function of attenuation per frequency in the object under evaluation. The display displays a graph of the determined attenuation-frequency function. In another embodiment, acoustic velocity is measured in several different locations on an object under evaluation. A location-monitoring device determines the location in which an acoustic velocity is measured. The determined location is stored in memory along with the acoustic velocity measured in that location. After obtaining a desired amount of acoustic velocities in different locations, the computer sends the accumulated measurements to a display, which displays an image of the object under evaluation, based on the acoustic velocities measured in different locations on the object.

### FIELD AND BACKGROUND OF THE INVENTION

The present invention relates in general to ultrasonic techniques for measuring ultrasonic properties of an object and, in particular, it discloses a method and apparatus for measuring acoustic velocities and ultrasonic attenuation-frequency functions within an object.

Every object in nature possesses various ultrasonic properties. One such property is the acoustic velocity within an object (commonly described by the symbol “c”). The acoustic velocity in an object is the speed at which a sound wave propagates through the object. Another ultrasonic property is the attenuation coefficient of an object, which is the decrease in the intensity of a sound wave of a certain frequency as it traverses the object. The attenuation coefficient of an object depends, among other factors, on the frequency of the sound wave traversing the object. More specifically, the higher the frequency of a sound wave traversing an object, the higher the attenuation of the object will be with respect to that sound wave. The function correlating between the attenuation coefficient of an object and the frequency of a sound wave traversing the object, is herein referred to as the “attenuation-frequency function”.

Ultrasonic properties of an object, such as its acoustic velocity “c” and its attenuation-frequency function, have various practical uses in ultrasonic technologies. The acoustic velocity of an object is an important factor, for example, in determining the location of a flaw within an object under test, in such ultrasonic imaging systems and methods which are based on measurement of travel time of ultrasonic pulses within the object. In such techniques, the location of a flaw within an object is typically deduced using the equation:

d_{f}=c*t

wherein “d_{f}” is the distance between the scanning surface of the object and the flaw within the object; “t” is the travel time of ultrasonic energy from the scanning surface of the object to the flaw; and “c” is the acoustic velocity within the object, which is predetermined using prior art techniques for measuring acoustic velocity.

The attenuation-frequency function is also a useful factor, for example, in various ultrasonic imaging techniques. Knowing an attenuation-frequency function of an object under test, an operator of an ultrasonic imaging system can establish a proper frequency range with which to scan that specific object. In other words, the attenuation-frequency function enables an operator to determine a frequency threshold above which ultrasonic reflections from an object would be too weak or with an amplitude too low, for a certain imaging system to make use of such reflections.

It is therefore evident that a method and apparatus which would measure ultrasonic properties of an object, in particular, its acoustic velocity “c” and its attenuation-frequency function, in a reliable and precise yet economical manner, would reasonably enhance the performance of existing ultrasonic technologies, as well as allow for further advances in ultrasonic technologies.

Unfortunately, existing methods and apparatuses for measuring ultrasonic properties of an object, such as its acoustic velocity and its attenuation-frequency function, suffer from a number of disadvantages, as will be explained in detail hereunder after a brief description of existing techniques.

Existing techniques for measuring acoustic velocity “c” in an object are typically based on measurement of ultrasonic travel time within the object. Thus, a prior art method typically includes the steps of: transmitting pulses of ultrasonic energy toward a scanning surface of an object under evaluation with a predetermined thickness “'dₜ”, and into the interior of the object; receiving echoes of ultrasonic pulses reflected from a surface opposite to the scanning surface of the object; measuring the travel time or time of flight “t” of the pulses within the object, from first transmittal of pulses to first receipt of echoes reflected from the opposite surface; and calculating acoustic velocity “c” based on thickness “dₜ” and travel time “t”, using the following equation:

c=2*dₜ\t

Existing techniques for measuring an attenuation-frequency function in an object are typically based on measurement of ultrasonic amplitude reduction within the object. A prior art method typically includes the steps of: generating ultrasonic pulses in a predetermined frequency and amplitude; transmitting the pulses into the interior of an object under evaluation with a predetermined thickness; receiving echoes of the ultrasonic pulses reflected from within the object; measuring the amplitude of the echoes; comparing the amplitude of the transmitted pulses to the amplitude of the received pulses, whilst taking into account the total distance traveled by the pulses within the object, which equals twice the predetermined thickness of the object; calculating an amplitude reduction factor based on the above mentioned comparison; providing a memory for storing a set comprising the frequency of the transmitted pulses along with a corresponding amplitude reduction factor; repeating the steps described herein above, each time generating and transmitting pulses in a different frequency, until a desired number of sets is stored and accumulated; and displaying an attenuation-frequency function, based on the accumulated sets.

As mentioned herein above, existing techniques for measuring ultrasonic properties in an object, in particular, acoustic velocity and attenuation-frequency function, suffer from several major deficiencies.

One principle problem of prior art methods and apparatuses is that, in practice, they tend to produce results with low levels of precision. This problem is essentially an outcome of the interference phenomenon: when transmitting ultrasonic pulses toward an object, often transmitted pulses interfere with pulses reflected from the object; in addition, pulses reflected from one point in the object often interfere with pulses reflected from another point in the object. Interference tends to be more intense in objects that are relatively thin, meaning that there is a relatively small distance between the scanning surface of the object and the surface opposite to the scanning surface. The interference phenomenon makes it difficult, and sometimes even impossible, to distinguish between transmitted pulses and reflected pulses, or between pulses reflected from the scanning surface of an object and pulses reflected from the opposite surface thereto, thus making it difficult or impossible to measure ultrasonic travel time within the object. Since existing methods and apparatuses for measuring acoustic velocity in an object are based on travel time measurements, consequently the interference phenomenon leads to poor or imprecise measurement of acoustic velocity. Similarly, since the interference phenomenon often causes substantial deviation in ultrasonic amplitude measurements within the object, consequently this phenomenon also causes errors and imprecision in prior art measurement of attenuation-frequency function.

Another problem in prior art techniques is that these techniques tend to produce, in practice, results with a low level of repeatability. When performing several prior art measurements of travel time and amplitude reduction on the same object, it is difficult to reconstruct identical measuring conditions, such as the location of the transmitting and receiving element in relation to the object. Therefore, it is not uncommon to achieve different travel time and amplitude reduction measurements for the same object. Subsequently, prior art apparatuses often produce different acoustic velocity and attenuation-frequency function measurements for the very same object.

A further limitation of prior art apparatuses is that since such apparatuses concentrate on changes in the travel time and amplitude of ultrasonic pulses, they overlook changes in the frequency spectrum of transmitted ultrasonic pulses as they are reflected from an object. Such changes also possess information, which is very useful for measuring ultrasonic properties of an object.

Another problem with prior art methods of operation, as will be evident from their detailed description here under, is that they are not fully automated and they require significant human operator intervention, which further increases the risk of errors.

Referring now to FIG. 1, a prior art apparatus 40 for measuring acoustic velocity within an object will be described. Apparatus 40 comprises essentially six main elements: a pulse generator 42, a transducer 44, a time measurement mechanism 48, a computer 50, a computer control element 50′ and a display 52.

The objective of apparatus 40 is to measure and display an acoustic velocity “c” within an object under evaluation. Object 30 is an example of an object under evaluation. Object 30 is in the form of a layer with a predetermined thickness “d₃₀”. Object 30 comprises two parallel opposite surfaces, a first surface 32 and a second surface 34.

Apparatus 40 operates as follows. Thickness “d₃₀” of object 30 is predetermined using conventional measuring means and is fed into computer control element 50′ by an operator of the system. Following, pulse generator 42 generates and produces an output of electronic pulses. Transducer 44 receives electronic pulses from generator 42, converts these pulses into ultrasonic pulses and transmits the ultrasonic pulses toward scanning surface 32 of object 30 in a normal (perpendicular) incidence. The ultrasonic pulses transmitted by transducer 44 partially penetrate object 30 in point 36 on scanning surface 32. At the same time that the ultrasonic pulses first traverse point 36, transducer 44 sends a first signal to time measurement mechanism 48. Upon receiving a first signal from transducer 44, mechanism 48 starts measuring time. Meanwhile, the penetrating pulses travel within object 30 partially along trajectory 37 until they reach the inner side of opposite surface 34 at point 38. These pulses are then partially reflected from point 38 back toward point 36 along trajectory 37. Transducer 44 receives ultrasonic pulses reflected back to point 36. At the same time that transducer 44 detects ultrasonic echo pulses arriving back at point 36, the transducer sends a second signal to time measurement mechanism 48. Upon receiving a second signal from transducer 44, mechanism 48 stops measuring time. As a result of the method of operation described heretofore, mechanism 48 determines the travel time or time of flight “t” of ultrasonic pulses traveling from surface 32 to opposite surface 34 and back to surface 32, a distance equivalent to twice predetermined thickness “d₃₀”. Mechanism 48 sends travel time “t” to computer 50. Computer 50 further receives thickness “d₃₀” from element 50′. Computer 50 then calculates acoustic velocity “c” using the following equation:

c=2*d₃₀/t

Finally, computer 50 sends acoustic velocity “c” measured in object 30 to display 52, which displays it.

Referring now to FIG. 2 a prior art apparatus 60 for measuring an attenuation-frequency function within an object, will be described. Apparatus 60 comprises some elements similar to those of prior art apparatus 40, and therefore common elements will be denoted hereunder with same reference numerals. Thus, apparatus 60 comprises a pulse generator 42, a transducer 44, a computer 50, a first computer control element 50′ and a display 52, all similar to those used in aforementioned apparatus 40. In addition, apparatus 60 further comprises a second computer control element 50″, an amplitude measurement device 62 and a computer memory 65. Apparatus 60 does not comprise a time measurement mechanism.

The objective of prior art apparatus 60 is to measure and display an attenuation-frequency function in an object under evaluation. Object 30 is an example of an object under evaluation with a predetermined thickness “d₃₀”, identical to object 30 described hereinabove in reference to FIG. 1.

The method of operation of apparatus 60 is as follows. Thickness “d₃₀” of object 30 is predetermined and fed by the operator of apparatus 60 into computer control element 50′. Following, the operator of apparatus 60 selects a desired frequency and feeds it into pulse generator 42 and into computer control element 50″. Then, the operator selects a desired amplitude and feeds it into transducer 44. Pulse generator 42 generates electronic pulses in the selected frequency and sends these pulses to transducer 44. The transducer converts the electronic pulses into ultrasonic pulses in the selected frequency and in the selected amplitude, and transmits these ultrasonic pulses toward scanning surface 32 of object 30 in a normal (perpendicular) incidence. The ultrasonic pulses transmitted by the transducer partially penetrate object 30 in point 36 on scanning surface 32 and then travel in trajectory 37 toward point 38 on opposite surface 34. Upon arriving at point 38 the pulses are partially reflected back toward point 36, again along trajectory 37. After having traveled within object 30 from point 36 to point 38 and back, a total travel distance equivalent to twice predetermined thickness “d₃₀”, the reflected pulses are then received by transducer 44 at point 36. The transducer sends the received pulses to amplitude measurement device 62. Device 62 measures the amplitude of the received pulses and sends an amplitude measurement to computer 50. Computer 50 sends the amplitude measurement along with its corresponding frequency (received from element 50″) to computer memory 65 which records the amplitude and frequency as a first set.

The method of operation described above is repeated by the operator of the system, each time selecting a different frequency, until a desired number of sets of amplitude and frequency is accumulated in memory 65. Finally, computer 50 retrieves from memory 65 all the sets accumulated, and sends them to display 52. Display 52 displays an attenuation-frequency function based on the accumulated sets, for example by drawing an amplitude per frequency graph, plotting a point on the graph for each set of the accumulated sets, and connecting the plotted points to form an attenuation-frequency function.

The following is a cross-reference list of related prior art patents and published patent applications:

| | |
|---|---|
| U.S. Pat. No. 5533402 | Sarvazyan et al. |
| U.S. Pat. No. 5166910 | Batzle et al. |
| U.S. Pat. No. 4364114 | Renzel et al. |
| U.S. Pat. No. 4210028 | Hilderbrand |
| U.S. Pat. No. 4114455 | Walker |
| Japanese Pat. no. 63247608A | Yamaguchi Tetsuo |
| Japanese Pat. no. 59183364A | Nakabachi Noritoshi et al. |
| Japanese Pat. no. 59119222A | Tomeno Izumi et al. |
| Japanese Pat. no. 09189686A | Endo Tomio |
| Japanese Pat. no. 08299336A | Kawan Sutanto et al |
| Japanese Pat. no. 05223790A | Takeda Sakae |
| Japanese Pat. no. 02236449A | Masaike Hiromi et al. |

### SUMMARY OF THE INVENTION

The present invention disclosed herewith is an ultrasonic method and apparatus for measuring ultrasonic properties in an object under evaluation, in particular, acoustic velocities and ultrasonic attenuation-frequency functions within an object.

According to the teachings of the present invention there is provided a method for measuring acoustic velocity within an object under evaluation, the object under evaluation having a predetermined thickness, including the steps of: (a) transmitting a first train of ultrasonic energy toward a reference object; (b) receiving echoes of the first train of ultrasonic energy reflected from the reference object; (c) transmitting a second train of ultrasonic energy, identical to the first train of ultrasonic energy, toward a surface of the object under evaluation; (d) receiving echoes of the second train of ultrasonic energy reflected from the object under evaluation; and (e) comparing the received echoes of the first train to the received echoes of the second train to determine the acoustic velocity.

There is further provided a method for measuring an attenuation-frequency function within an object under evaluation, including the steps of: (a) transmitting a first train of ultrasonic energy toward a reference object; (b) receiving echoes of the first train of ultrasonic energy reflected from the reference object; (c) transmitting a second train of ultrasonic energy, identical to the first train of ultrasonic energy, toward the object under evaluation; (d) receiving echoes of the second train of ultrasonic energy reflected from the object under evaluation; and (e) comparing the received echoes of the first train to the received echoes of the second train to produce the attenuation-frequency function.

There is further provided an apparatus for measuring an ultrasonic property of an object under evaluation, including: (a) a reference object; (b) a transducer for transmitting a first train of ultrasonic energy toward the reference object, for receiving echoes of the first train of ultrasonic energy reflected from the reference object, for transmitting a second train of ultrasonic energy identical to the first train of ultrasonic energy toward the object under evaluation, and for receiving echoes of the second train of ultrasonic energy reflected from the object under evaluation; (c) a digitizer for converting the received echoes of the first train into a first digital output and for converting the received echoes of the second train into a second digital output; and (d) a computer for comparing the first digital output to the second digital output to determine the ultrasonic property.

Accordingly, several objects and advantages of the present invention are:

(i) to provide an apparatus and method for measuring ultrasonic properties of an object under evaluation, which would not be affected by interference occurring in ultrasonic energy reflected from the object;

(ii) to provide a reliable apparatus and method for measuring ultrasonic properties of an object under evaluation, which will produce precise results regardless of the thickness of the object.

(iii) to provide an apparatus and method for measuring ultrasonic properties of an object under evaluation, producing similar results when applied several times to the same object;

(iv) to provide an apparatus and method for measuring ultrasonic properties of an object, in a manner which is independent of travel time measurements within the object;

(v) to provide an apparatus and method for measuring ultrasonic properties of an object, with capabilities of accumulating and imaging several such measurements performed at different locations on the object;

(vi) to provide an apparatus for measuring ultrasonic properties of an object under evaluation, comprising conventional, economical and easily attainable elements; and

(vii) to provide an apparatus for measuring ultrasonic properties of an object, which operates with minimal human intervention, thus reducing the risk of errors.

### BRIEF DESCRIPTION OF THE DRAWINGS

The invention is herein described, by way of example only, with reference to the accompanying drawings, wherein:

FIG. 1 is a schematic illustration of a prior art apparatus for measuring acoustic velocity within an object under evaluation.

FIG. 2 is a schematic illustration of a prior art apparatus for measuring an attenuation-frequency function within an object under evaluation.

FIG. 3 is a schematic illustration of a preferred embodiment of the present invention, applied to a reference object.

FIG. 4 is a schematic illustration of a preferred embodiment of the present invention, applied to an object under evaluation.

FIG. 5 is a graph depicting an amplitude per frequency array produced and used by a preferred embodiment of the present invention.

FIG. 6 is a graph depicting an attenuation-frequency function measured and displayed by the preferred embodiment of the present invention.

FIG. 7 is a schematic illustration of an ultrasonic measuring, mapping and imaging apparatus according to an alternative embodiment of the present invention.

### REFERENCE NUMERALS IN THE DRAWINGS

REFERENCE NUMERALS IN THE DRAWINGS

| | | | |
|---|---|---|---|
| 30 | example of an object under | 200 | preferred embodiment |
| | evaluation | | |
| 32 | first surface of object 30 | 210 | analog to digital |
| | | | converter |
| 34 | second surface of object 30 | 230 | example of a reference |
| | | | object |
| 36 | point on surface 32 | 232 | surface of object 230 |
| 37 | trajectory from point 36 to point 38 | 236 | point on surface 232 |
| 38 | point on surface 34 | 300 | alternative |
| | | | embodiment |
| 40 | prior art apparatus for measuring | 310 | location-monitoring |
| | acoustic velocity | | device |
| 42 | pulse generator | | |
| 44 | transducer | | |
| 48 | time measurement mechanism | | |
| 50 | computer | | |
| 50’ | first computer control element | | |
| 50” | second computer control element | | |
| 52 | display | | |
| 60 | prior art apparatus for measuring | | |
| | attenuation-frequency function | | |
| 62 | amplitude measurement device | | |
| 65 | computer memory | | |

### DESCRIPTION OF THE PREFERRED EMBODIMENTS

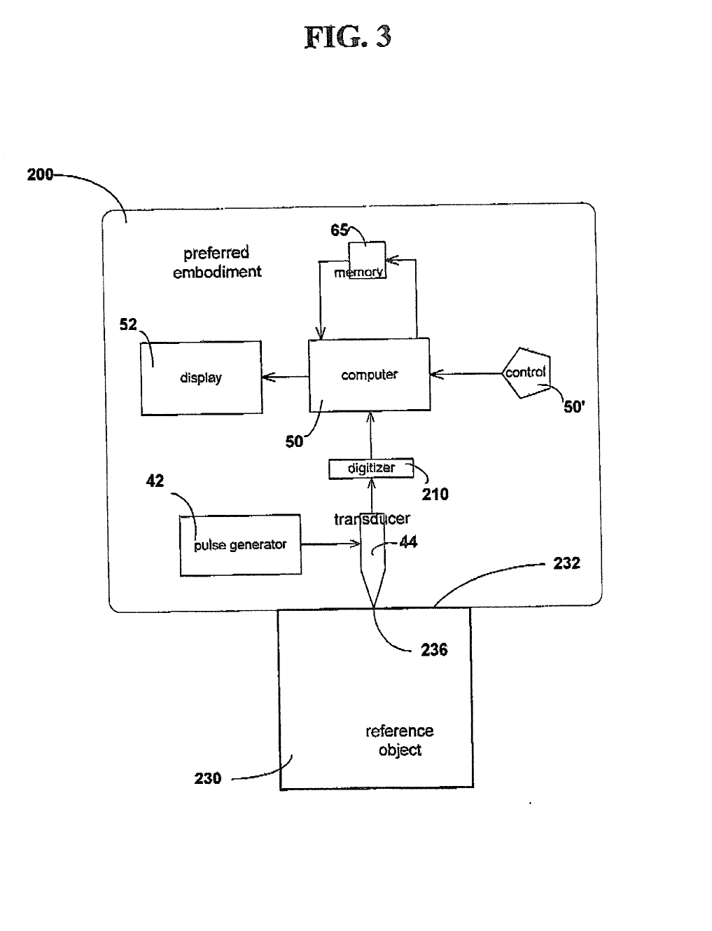

Referring now to FIG. 3, a preferred embodiment of the present invention, designated 200, will be described. Apparatus 200 is an apparatus for measuring ultrasonic properties of an object under evaluation, in particular, acoustic velocity “c” within an object and an attenuation-frequency function in the object.

Apparatus 200 comprises some elements similar to those of prior art apparatuses 40 and 60, and therefore common elements will be denoted hereunder with same reference numerals. Thus, preferred embodiment apparatus 200 comprises a pulse generator 42, a transducer 44, a computer 50, a first computer control element 50′, a display 52 and a computer memory 65, all similar to those used in prior art apparatuses 40 and 60. Apparatus 200 further includes an analog to digital converter 210. However, apparatus 200 does not include a time measurement mechanism 48, a second computer control element 50″ and an amplitude measurement device 62.

The objective of preferred embodiment 200 is to measure and display an acoustic velocity “c” and an attenuation-frequency function in an object under evaluation. In addition to an object under evaluation, apparatus 200 makes use of another object for reference purposes. The apparatus uses a reference object in order to produce and record a reference echo of ultrasonic pulses, which are reflected from a surface of the reference object. A reference echo is preferably a “clean” echo, meaning an echo containing pulses reflected mainly from a surface of the reference object, as opposed to pulses reflected from within the body of the reference object. The reference echo preferably contains few or no pulses reflected from within the body of the reference object. It is important to record a “clean” echo as a reference echo, in order to minimize the risk of interference between transmitted and reflected ultrasonic pulses within an echo which is serving for reference purposes.

Still referring to FIG. 3, the method of operation of apparatus 200 in recording a reference echo will be described. Object 230 is an example of a reference object. Object 230 comprises a surface 232. Pulse generator 42 generates and produces an output of electronic pulses. Transducer 44 receives electronic pulses from generator 42, converts these into ultrasonic pulses, and transmits the ultrasonic pulses toward surface 232 of object 230 in a normal (perpendicular) incidence. The transmitted ultrasonic pulses are reflected from surface 232 in point 236. Transducer 44 receives the echo of ultrasonic pulses reflected from surface 232 and converts these into electronic pulses. Analog to digital converter 210 receives the electronic pulses from transducer 44 and converts them to a digital output. Computer 50 receives from converter 210 the digital representation of the received ultrasonic echo pulses, and processes the digital information using a Fast Fourier Transform (FFT) algorithm. The FFT process results in an array of amplitudes per frequencies (i.e., a frequency spectrum), each frequency with a corresponding amplitude value. Computer memory 65 receives from computer 50 the array of amplitudes per frequencies produced from the reference echo, and records this array as a first array.

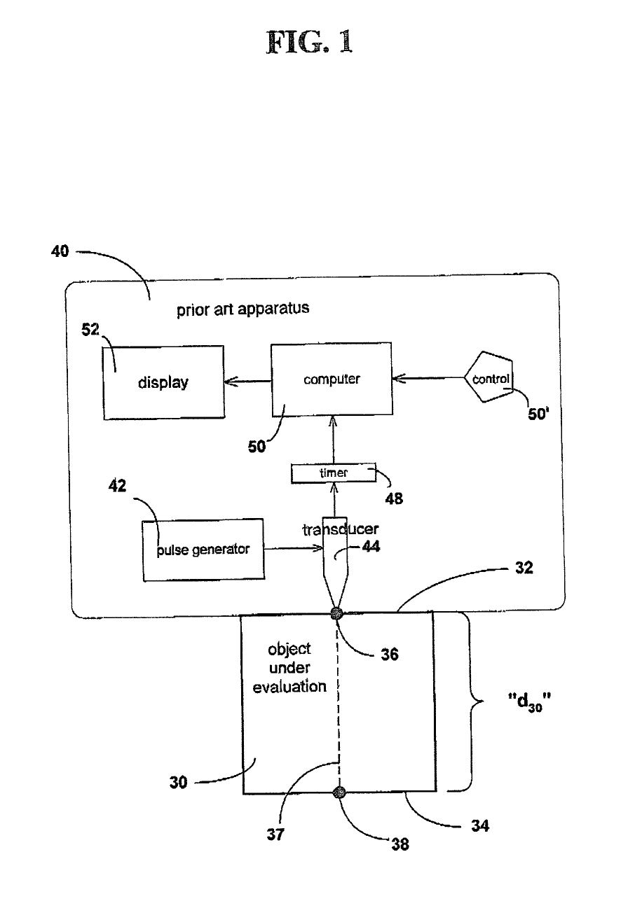

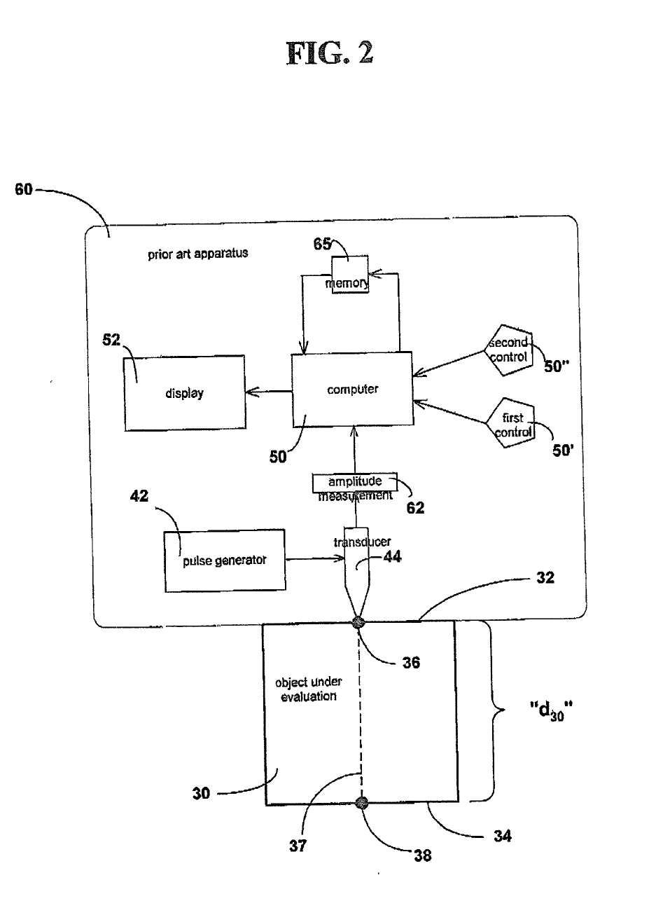

Apart from recording a reference echo as described hereinabove, apparatus 200 records a “real” echo, meaning an ultrasonic echo reflected from the object under evaluation. An echo from the object under evaluation may be a “dirty” echo, meaning an echo with interference occurring between pulses reflected from the surface of the object and pulses reflected from within the body of the object. As opposed to prior art apparatus 40 described hereinabove in reference to FIG. 1, preferred embodiment apparatus 200 is capable of measuring acoustic velocities in relatively thin objects, in spite of the interference phenomenon.

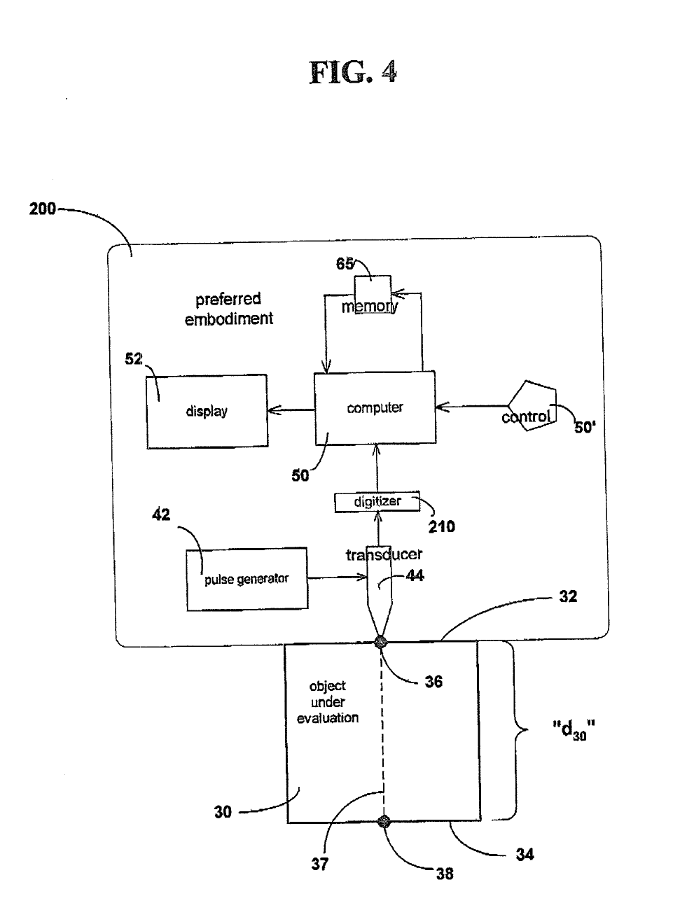

Referring now to FIG. 4, the method of operation of apparatus 200 in recording an echo reflected from an object under evaluation will be described. Object 30 is an example of an object under evaluation with a predetermined thickness “d₃₀”. The object is identical to object 30 described hereinabove in reference to FIG. 1.

The echo from object under evaluation 30 is recorded as follows. Transducer 44 transmits toward surface 32 in a normal (perpendicular) incidence, a train of ultrasonic pulses identical to that which it transmitted toward the reference object for the purpose of recording a reference echo. Some of the transmitted ultrasonic pulses are reflected back toward transducer 44 from point 36 on surface 32. Other transmitted pulses penetrate into object 30 through point 36, and are then reflected back toward transducer 44 from point 38 on the inner side of opposite surface 34. Transducer 44 receives in ultrasonic echo containing an indistinguishable combination of ultrasonic pulses, some of which are reflected from surface 32 and some others of which are reflected from within object 30. Transducer 44 then converts these ultrasonic echo pulses into electronic pulses. Analog to digital converter 210 receives the electronic pulses from transducer 44 and converts them to a digital output. Computer 50 receives from converter 210 a digital representation of the received ultrasonic echo pulses, and processes the digital information using a Fast Fourier Transform (FFT) algorithm. The FFT process results in an array of amplitudes per frequencies, each frequency with a corresponding amplitude value. Computer memory 65 receives from computer 50 the array of amplitudes per frequencies produced from the echo reflected from the object under evaluation, and records this array as a second array.

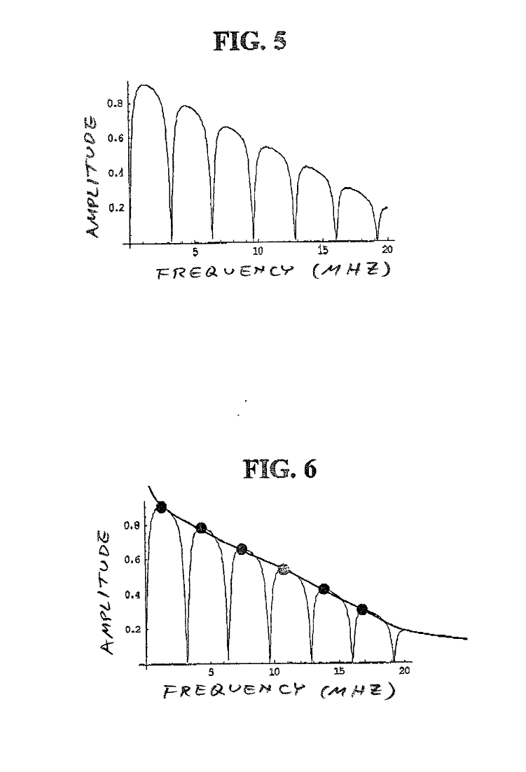

Computer 50 receives from computer memory 65 the first array and the second array of amplitudes per frequencies. Computer 50 divides the amplitudes of the second array by the amplitudes of the first array. The result is a third array of amplitudes per frequencies which is recorded in memory 65. The third array typically resembles, at least in part, the pattern illustrated in FIG. 5.

Referring now to FIG. 5, an example of a third array of amplitudes per frequencies, produced by preferred embodiment apparatus 200, will be described. FIG. 5 is a graph of amplitudes per frequencies, wherein the x-axis is a frequency axis and the y-axis is an amplitude axis. The frequency axis (x-axis) is scaled from 0 MHz to about 20 MHz. The amplitude axis (y-axis) is scaled from 0 to 1 and it is normalized in such a manner, that the highest amplitude in the graph receives a value of 1, and any lower amplitude in the graph receives a value between 0 and 1, correlative to its actual value.

It is clearly apparent in FIG. 5, that a typical third array is characterized, at least in part, by a periodical increase and decrease in amplitude, as frequency increases. Each periodical increase and decrease in the amplitude axis (y-axis) of the array, is herein referred to as a “repeating occurrence”. In FIG. 5, for example, six repeating occurrences are apparent: a first occurrence appears approximately between 0 MHz and 3 MHz; the occurrence is repeated approximately between 3 MHz and 6 MHz; and is repeated again approximately between 6 MHz and 9 MHz, etc.

The frequency in which periodical increases and decreases in amplitude are repeated, or in other words, the frequency of recurrence of periodical increase and decrease in amplitude, is herein referred to as the “frequency difference between repeating occurrences”. In FIG. 5, for example, the frequency difference between repeating occurrences is approximately 3 MHz: the first occurrence lying approximately between 0 MHz to 3 MHz, the second occurrence lying approximately from 3 MHz to 6 MHz, the third occurrence approximately from 6 MHz to 9 MHz, etc.

After a third array is produced by apparatus 200 as described hereinabove, the frequency difference between repeating occurrences within the third array is determined, either manually by an operator of apparatus 200 or automatically by the apparatus, using an algorithm designed for this purpose. According to the present invention, an algorithm for determining the frequency difference between repeating occurrences includes the following steps: Computer 50 chooses a hypothetical frequency difference between repeating occurrences, designated “fₕ”, for example “fₕ=7 MHz”. Computer 50 gets from the third array a first set of frequencies, containing frequencies which lie closest to a full frequency cycle of hypothetical frequency difference “fₕ”. For example, if “fₕ=7 MHz” then computer 50 gets a set of frequencies, containing the frequency which is lying closest to 7 MHz, the frequency lying closest to 14 MHz, the frequency lying closest to 21 Mhz, etc. Next, computer 50 gets from the third array a first set of amplitudes, containing all amplitudes of frequencies contained in the first set of frequencies. Computer 50 then calculates a first sum, summing up all amplitudes collected in the first set of amplitudes.

Following, computer 50 gets from the third array a second set of frequencies, containing frequencies which lie closest to a maximum point between every two consecutive full frequency cycles of hypothetical frequency difference “fₕ”. For example, if “fₕ=7 MHz”, then computer 50 gets a set of frequencies, containing the frequency lying closest to a maximum point between 0 MHz and 7 MHz, the frequency lying closest to a maximum point between 7 MHz and 14 MHz, the frequency lying closest to a maximum point between 14 MHz and 21 MHz, etc. Next, computer 50 gets from the third array a second set of amplitudes, containing all amplitudes of frequencies contained in the second set of frequencies. Computer 50 then calculates a second sum, summing up all amplitudes collected in the second set of amplitudes. The computer subtracts the first sum from the second sum. The computer records the result of the subtraction in memory 65 as a first result, along with the hypothetical frequency difference “fₕ” which produced that result.

Computer 50 repeats the steps of the algorithm described hereinabove, each time with a different hypothetical frequency “fₕ” value, and each time recording a new result, until a desired number of results is accumulated and stored in memory 65.

The computer gets all results stored in memory 65 and finds the maximum result. Subsequently, the computer finds the hypothetical frequency difference “fₕ” which produced the maximum result. The “real” frequency difference between repeating occurrences in the third array, designated hereunder by the symbol “fr”, equals the hypothetical frequency “fₕ” which produced the maximum result. The computer records the determined “real” frequency difference “fᵣ” in memory 65.

Predetermined thickness “d₃₀” of object 30 is fed into computer control element 50′. Computer 50 receives the value of “d₃₀” from control element 50′ and further receives the value of the determined frequency difference “fᵣ” from memory 65. Having acquired both thickness “d₃₀” and frequency difference “fᵣ”, computer 50 calculates acoustic velocity “C” in object 30, using the following conventional equation:

c=2* d30*fᵣ

Computer 50 records in memory 65 the determined acoustic velocity “c”. The computer sends the determined acoustic velocity “c” to display 52, which displays it.

An attenuation-frequency function in object under evaluation 30 is measured and displayed by apparatus 200 as follows. First, a third array of amplitudes per frequencies is produced and recorded in memory 65 using the method of operation described hereinabove in reference to FIG. 4. Second, the frequency difference “fᵣ” between repeating occurrences in the third array is determined and recorded in memory 65, using the method described hereinabove.

Having obtained a third array of amplitudes per frequencies and a frequency difference “fᵣ” between repeating occurrences in the third array, computer 50 gets from the third array a subset of amplitudes per frequencies, containing frequencies which lie closest to a maximum point between every two consecutive full frequency cycles of determined frequency difference “fᵣ”, each frequency being recorded in the subset along with its corresponding amplitude value from the third array. The computer records the subset of amplitudes per frequencies in memory 65.

Display 52 receives from memory 65 the recorded subset of amplitudes per frequencies, and displays an attenuation-frequency function based on that subset. The displayed attenuation-frequency function, typically resembles a hyperbolic function.

Referring now to FIG. 6, an example of an attenuation-frequency function measured and displayed by preferred embodiment apparatus 200, will be described. FIG. 6 is a graph of amplitudes per frequencies, similar to the graph illustrated in FIG. 5 in that the x-axis is a frequency axis and the y-axis is an amplitude axis. In FIG. 6, a function of a typical third array, identical to that of FIG. 5, is plotted. Accordingly, as in FIG. 5, six repeating occurrences are apparent in the third array depicted in FIG. 6.

In addition to a depiction of the third array, FIG. 6 also depicts the subset of amplitudes per frequencies, containing frequencies which lie closest to a maximum point between every two consecutive full frequency cycles of determined frequency difference “fᵣ”. In FIG. 6, six such maximum points are marked by black dots, the first maximum point being located approximately at coordinate (1.5, 1), the second—approximately at (4.5, 0.8), the third—approximately at (7.5, 0.7), etc.

Finally, the graph in FIG. 6 displays an attenuation-frequency function, which consists of a line connecting between all maximum points contained in the subset of amplitudes per frequencies.

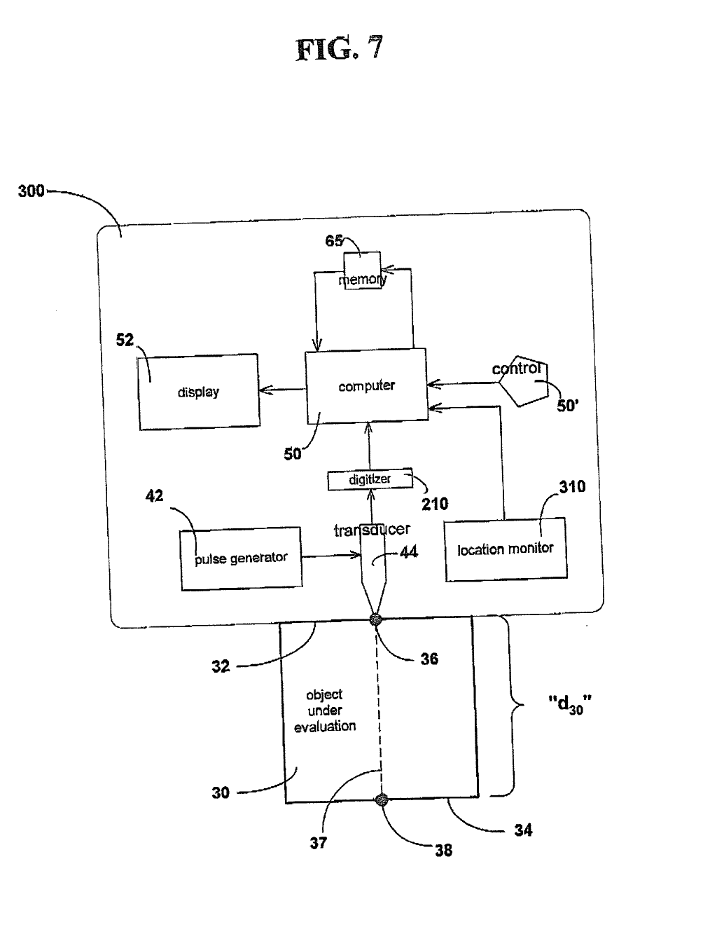

Referring now to FIG. 7, an alternative embodiment of the present invention, designated 300, will be described. Apparatus 300 is an apparatus for measuring, mapping and imaging acoustic velocities within an object under evaluation, for example, object 30. Apparatus 300 comprises all the elements contained in apparatus 200, and further includes a location-monitoring device 310 for providing the location of transducer 44 in relation to object 30.

Device 310 determines the location of the transducer using a conventional method of emitting an acoustic signal from an emitter positioned on the transducer; receiving the signal by three different receptors, each of which is located in a different predetermined location; measuring the travel time of the signal from the transducer to each receptor; calculating the distance from each receptor to the transducer, based on the predetermined travel time and acoustic velocity of the signal; and determining a three-axis coordinate location of the transducer based on the predetermined distance from each receptor to the transducer. Device 310 sends the determined location of transducer 44 to computer 50, which records the location in memory 65 along with the matching acoustic velocity measured at the same location. After measuring the acoustic velocity in different locations on object 30, using the measuring method described hereinabove in reference to FIG. 3 and FIG. 4, computer 50 gets from memory 65 a list of measured acoustic velocities, each acoustic velocity along with the location on object 30 at which it was measured, and sends this list to display 52.

Finally, display 52 displays a three-dimensional image of the object under evaluation, illustrating acoustic velocities measured in different points on the object, for example, by attributing different colors to different acoustic velocity ranges and coloring each point on the object with the color which matches the acoustic velocity measured on that point.

From the above description, a number of advantages of the present method and apparatus for measuring ultrasonic properties of an object become evident:

(i) The present invention provides more precise and reliable measurements of the acoustic velocity and attenuation-frequency function within an object;

(ii) The present invention provides measurements with a higher level of repeatability;

(iii) The measurements achieved by the present invention are less vulnerable to interference occurring in ultrasonic echo pulses reflected from the object;

(iv) The present invention provides a more automated method of operation, requiring only minimal supervision on behalf of a human operator;

(v) The present apparatus consists of only standard equipment, which is easily attainable; and

(vi) The present invention introduces a new image consisting of acoustic velocities measured in different locations on an object, such an image providing a more complete and comprehensible view of the object.

Thus, it becomes evident that the method and apparatus of the present invention provides a highly reliable and precise, yet economical method and apparatus for measuring ultrasonic properties of an object, in particular, acoustic velocities and an attenuation-frequency function within an object.

While preferred and alternative embodiments of the present invention have been disclosed heretofore, it is to be understood that these embodiments are given as examples only and not in a limiting sense. Those skilled in the art may make various modifications and additions to the preferred embodiments chosen to illustrate the invention without departing from the spirit and scope of the present contribution to the art.

The apparatus can obviously be enhanced to provide a fuller measurement or image of ultrasonic properties of an object, for example, by scanning more than one surface of the object.

Thus, it is to be realized that the patent protection sought and to be afforded hereby shall be deemed to extend to the subject matter claimed and all equivalence thereof fairly within the scope of the invention

While the invention has been described with respect to a limited number of embodiments, it will be appreciated that many variations, modifications and other applications of the invention may be made.

What is claimed is:

1. A method for measuring acoustic velocity within an object under evaluation, the object under evaluation having a predetermined thickness, comprising the steps of:
(a) transmitting a first train of ultrasonic energy toward a reference object;
(b) receiving echoes of said first train of ultrasonic energy reflected from said reference object;
(c) transmitting a second train of ultrasonic energy, identical to said first train of ultrasonic energy, toward a surface of the object under evaluation;
(d) receiving echoes of said second train of ultrasonic energy reflected from the object under evaluation; and
(e) comparing said received echoes of said first train to said received echoes of said second train to determine the acoustic velocity.

2. The method of claim 1, wherein said comparing is effected by steps including:
(i) transforming said echoes of said first train to produce a first frequency spectrum; and
(ii) transforming said echoes of said second train to produce a second frequency spectrum.

3. The method of claim 2, wherein said transforming is effected using a Fast Fourier Transform.

4. The method of claim 2, wherein said comparing is effected by steps further including:
(iii) dividing said first frequency spectrum by said second frequency spectrum to produce a third frequency spectrum;
(iv) determining a frequency difference between repeating occurrences in said third frequency spectrum; and
(v) calculating the acoustic velocity based on said frequency difference between repeating occurrences in said third frequency spectrum and on said predetermined thickness of said object under evaluation.

5. The method of claim 4, wherein said determining of a frequency difference between repeating occurrences in said frequency spectrum includes the steps of:
(A) selecting a hypothetical frequency difference;
(B) selecting a first set of frequencies from said frequency spectrum, each frequency of said set being a closest frequency to a respective multiple of said hypothetical frequency difference;
(C) summing amplitudes corresponding to said first set of frequencies, thereby obtaining a first sum;
(D) selecting a second set of frequencies from said frequency spectrum, each frequency of said second set being a closest frequency to a maximum point between two consecutive multiples of said selected hypothetical frequency difference;
(E) summing amplitudes corresponding to said second set of frequencies, thereby obtaining a second sum; and
(F) subtracting said first sum from said second sum to produce a result.

6. The method of claim 5, wherein said steps (A), (B), (C), (D), (E) and (F) are repeated, whilst in each repetition a different said hypothetical frequency difference is selected.

7. The method of claim 6, further including the step of:
(G) determining which of said hypothetical frequency differences produces a maximum result, said calculation of the acoustic velocity then being based on said hypothetical frequency difference that produces said maximum result.

8. The method of claim 1, wherein steps (c) through (e) are repeated at a plurality of locations on said surface of the object under evaluation to provide a map of acoustic velocity as a function of location on said surface of the object under evaluation.

9. The method of claim 8, further comprising the step of:
(e) displaying said map of acoustic velocity.

10. A method for measuring an attenuation-frequency function within an object under evaluation, comprising the steps of:
(a) transmitting a first train of ultrasonic energy toward a reference object;
(b) receiving echoes of said first train of ultrasonic energy reflected from said reference object;
(c) transmitting a second train of ultrasonic energy, identical to said first train of ultrasonic energy, toward said object under evaluation;
(d) receiving echoes of said second train of ultrasonic energy reflected from said object under evaluation; and
(e) comparing said received echoes of said first train to said received echoes of said second train to produce the attenuation-frequency function.

11. The method of claim 10, wherein said comparing is effected by steps including:
(i) transforming said first received echoes of said first train to produce a first frequency spectrum; and
(ii) transforming said second received echoes of said second train to produce a second frequency spectrum.

12. The method of claim 11, wherein said transforming is effected using a Fast Fourier Transform.

13. The method of claim 11, wherein said comparing is effected by steps further including:
(iii) dividing said first frequency spectrum by said second frequency spectrum to produce a third frequency spectrum; and
(iv) identifying a plurality of local maxima of said third frequency spectrum, said local maxima then defining the attenuation-frequency function.

14. The method of claim 13, wherein said identifying of said local maxima of said third frequency spectrum includes the steps of:
(A) selecting a hypothetical frequency difference;
(B) selecting a first set of frequencies from said frequency spectrum, each frequency of said set being a closest frequency to a respective multiple of said hypothetical frequency difference;
(C) summing amplitudes corresponding to said first set of frequencies, thereby obtaining a first sum;
(D) selecting a second set of frequencies from said frequency spectrum, each frequency of said second set being a closest frequency to a maximum point between two consecutive multiples of said selected hypothetical frequency difference;
(E) summing amplitudes corresponding to said second set of frequencies, thereby obtaining a second sum; and
(F) subtracting said first sum from said second sum to produce a result.

15. The method of claim 14, wherein said steps (A), (B), (C), (D), (E) and step (F) are repeated, whilst in each repetition a different said hypothetical frequency difference is selected.

16. The method of claim 15, wherein said identifying of said local maxima of said third frequency spectrum further includes the step of:
(G) determining which of said hypothetical frequency differences produces a maximum result, each said local maximum then being situated between two respective consecutive multiples of said hypothetical frequency difference that produces said maximum result.

17. An apparatus for measuring an ultrasonic property of an object under evaluation, comprising:
(a) a reference object;
(b) a transducer for transmitting a first train of ultrasonic energy toward said reference object, for receiving echoes of said first train of ultrasonic energy reflected from said reference object, for transmitting a second train of ultrasonic energy identical to said first train of ultrasonic energy toward the object under evaluation, and for receiving echoes of said second train of ultrasonic energy reflected from said object under evaluation;
(c) a digitizer for converting said received echoes of said first train into a first digital output and for converting said received echoes of said second train into a second digital output; and
(d) a computer for comparing said first digital output to said second digital output to determine the ultrasonic property.

18. The apparatus of claim 17, further including:
(e) a mechanism for monitoring a location of said transducer relative to the object under evaluation.

19. The apparatus of claim 17, further comprising:
(e) a display for displaying the ultrasonic property as determined by said computer.
